(19) United States
(12) Patent Application Publication
(10) Pub. No.: US 2007/0258435 A1
(43) Pub. Date: Nov. 8, 2007

(54) Maintenance device, terminal device and IP telephone system

(76) Inventors: Shiro Saito, Tokyo (JP); Kazuhiko Seki, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/398,795

(22) Filed: Apr. 6, 2006

(51) Int. Cl. H04L 12/66

(52) U.S. Cl. 370/352

(57) ABSTRACT

A maintenance device connected to a terminal device having an IP address via a network, comprising generation means for generating a packet storing a predetermined maintenance information for the terminal device in a data format according to a predetermined call control protocol, and transmission means for transmitting a packet generated by the generation means to the terminal device.

### BACKGROUND OF THE INVENTION

The present invention relates to a management technology of an IP telephone system for performing communication services, such as calling, using VoIP (Voice over Internet Protocol), and more particularly to an improvement technology of a maintenance device which performs processing on maintenance of the terminal device.

Recently a technology to perform voice conversation using Internet Protocol (IP) is receiving attention and expanding. This call technology is called an “IP telephone” or “IP telephone system”. In an IP telephone, voice signals corresponding to voice spoken by a user are converted into digital data, where predetermined compression processing is performed and packetized, then sent to the call destination via the network. At the call destination, analog voice signals are restored using the received packets, and voice is output. This technology for transmitting/receiving voice data using Internet protocol is called VoIP (Voice over Internet Protocol). A prior art on the IP telephone is disclosed, for example, in Japanese Patent Application Laid-Open No. 2001-177577.

### SUMMARY

To construct such an IP telephone system, a maintenance device is normally connected to the IP telephone via a predetermined network. The maintenance device is for performing maintenance of IP telephones, such as status management and update of programs, and by sending an information collection request and information update request to the IP telephone according to a predetermined control procedure, status information can be replied to the IP telephone, or setting of the IP telephone can be updated.

However such a maintenance device is often managed by an outside vendor who constructed the IP telephone system. Therefore when the IP telephone system is constructed, the maintenance device may be installed not in an internal network to which the IP telephone system is connected (e.g. LAN: Local Area Network), but to an external network (e.g. Internet). And in the case of such a configuration, the following problems occur.

Normally a so called “firewall” is installed at the boundary between an internal network and external network in order to prevent the invasion of a third party through the external network. The firewall is for monitoring the flow of internal and external data and restricting unnecessary access. Therefore if the control procedure for maintenance and maintenance information, which the maintenance device uses, do not match the specifications being set by the firewall, the control procedure and maintenance information cannot pass through the firewall, and maintenance management for the IP telephone system from the outside becomes difficult.

To prevent this problem, it is possible to install the maintenance device not outside but in the internal network so that the firewall need not be passed through, but installing the maintenance device in the internal network increases work and cost to construct and operate the system, which is not appropriate. Another possible method is changing the specifications of the maintenance device according to the setting of the firewall, but in this case, the specifications of the maintenance device depends on the setting of each firewall, so universality is lost and design cost of the maintenance device increases, which are not appropriate.

Therefore a maintenance device which can execute maintenance control of the IP telephones without being subject to the influence of a firewall, even if a firewall exists between the maintenance device and IP telephone, is desired.

With the foregoing in view, it is an object of the present invention to provide an optimum maintenance device for an IP telephone system for transmitting/receiving voice data using Internet protocol.

It is another object of the present invention to construct an IP telephone system that can perform maintenance of IP telephones from an external network, while maintaining security for the IP telephones.

To achieve the above objects, the maintenance device of the present invention is a maintenance device connected to a terminal device having an IP address via a network, comprising: generation means for generating a packet storing predetermined maintenance information for the terminal device in a data format according to a predetermined call control protocol; and transmission means for transmitting a packet generated by the generation means to the terminal device.

According to the present invention, a packet storing maintenance information according to a predetermined call control protocol is generated, so the maintenance information can be transmitted as if it were call control information, and as a result, maintenance information can be transmitted to the terminal with certainty, even if a firewall is installed between the maintenance device and the terminal device. The maintenance information may be transmitted as if it were the telephone number of the maintenance device.

It is preferable that the generation means stores predetermined maintenance information for the terminal device in an unspecified portion (a predetermined portion not used for call control) in a message field.

It is also preferable that the generation means stores predetermined maintenance information for the terminal device in text format.

It is also preferable that the predetermined maintenance information includes setting information to be set in the terminal device.

It is also preferable that the setting information is a control module for executing call processing.

It is also preferable that the setting information includes a table where a plurality of call destinations and a sequence of numbers assigned to each of the plurality of call destinations are corresponded.

The predetermined maintenance information is a request to collect a predetermined information for the terminal device.

The terminal device of the present invention is a terminal device connected to a server via a network, comprising: receive means for receiving a packet generated according to a predetermined call control protocol; extraction means for extracting a predetermined information included in a packet received by said receive means; and management means for executing processing according to maintenance information if the predetermined information extracted by the extraction means is maintenance information.

The terminal device of the present invention further comprises call control means for executing processing according to the information on call control if the predetermined information extracted by the extraction means is information on call control.

The extraction means extracts the maintenance information from the unspecified portion in the message field of the packet received by the receive means.

The extraction means extracts a predetermined information stored in text format in the packet received by the receive means.

The management means updates setting content being set according to the maintenance information if the maintenance information is an information setting request to the management means itself.

The IP telephone system of the present invention is an IP telephone system, comprising a terminal device having an IP address, and a maintenance device connected to the terminal device via a network, wherein the maintenance device comprises generation means for generating a packet storing predetermined maintenance information for the terminal device in a data format according to a predetermined call control protocol, and transmission means for transmitting a packet generated by the generation means to the terminal device. The terminal device comprises receive means for receiving a packet transmitted by the transmission means, extraction means for extracting a predetermined maintenance information included in a packet received by the receive means, and management means for executing processing according to predetermined maintenance information extracted by the extraction means.

As described above, according to the present invention, an optimum maintenance terminal device can be provided for an IP telephone system which transmits/receives voice data using Internet protocol.

Also according to the present invention, an IP telephone system, where maintenance for an IP telephone can be performed from an external network, can be constructed while insuring security for the IP telephone.

### DESCRIPTION OF THE DRAWINGS

FIG. 1 is a schematic diagram depicting the IP telephone system to which an embodiment of the present invention is applied;

FIG. 2 is a functional block diagram depicting the functions of the IP telephone terminal;

FIG. 3 is a functional block diagram depicting the function of the maintenance server;

FIG. 4A-4B show examples of the data configuration of an IP packet according to the present embodiment;

FIG. 5 is a flow chart depicting the processing procedure of the maintenance server;

FIG. 6 is a flow chart depicting the processing procedure of the IP telephone terminal 10; and

FIG. 7 is a flow chart depicting the processing procedure of the IP telephone terminal 10.

### DETAILED DESCRIPTION

### First Embodiment

Embodiments of the present invention will now be described with reference to the drawings. The maintenance terminal device according to the present invention is applied to an IP telephone system which performs conversation using VoIP (Voice over Internet Protocol).

[System Schematic Diagram]

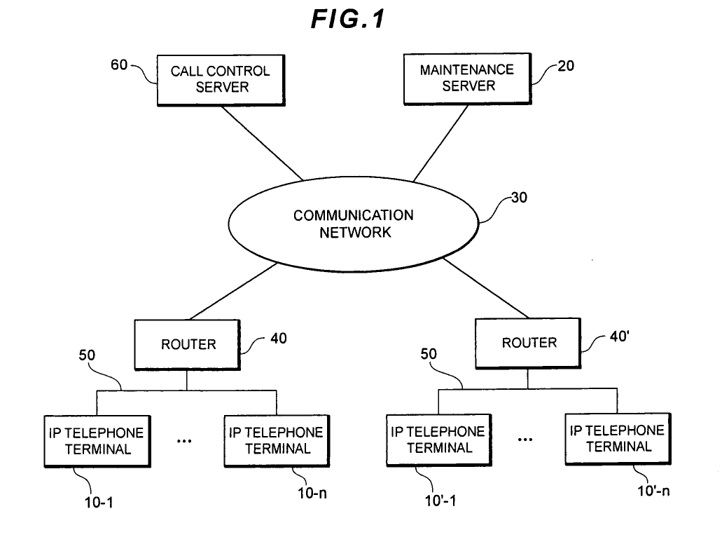

FIG. 1 is a schematic diagram of an IP telephone system to which an embodiment of the present invention is applied. As FIG. 1 shows, this IP telephone system comprises one or more IP telephone terminals 10-1 - - - 10-n, routers 40 which are connected to the IP telephone terminals 10 via LAN (Local Area Network) 50, a maintenance server 20 which is connected to the IP telephone terminals 10 via the router 40, and a predetermined communication network (e.g. Internet) 30, and a call control server 60 which is also connected to the IP telephone terminals 10 via the router 40 and the predetermined communication network 30 for managing calls of the IP telephone terminals 10.

Each IP telephone terminal 10 has a respective IP address, and comprises a voice encoding function for converting analog voice signals into digital signals, a packetizing function for processing the digitized voice signals to be IP packets, an address conversion function for converting the telephone number which is input from the input means, which is not illustrated, into the IP address to be the destination of the packets, and a call control function for managing the calls according to a predetermined call control protocol.

Examples of the call control protocol are the H.323 protocol to be used on TCP (Transmission Control Protocol) and SIP (Session Initialization Protocol) to be used on UDP (User Datagram Protocol). In the present embodiment, the case of using SIP will be described as an example. In this case, the IP terminal 10 functions as an SIP client.

The IP telephone terminal 10 according to the present embodiment is a single device having the above functions, but the configuration of the IP telephone terminal 10 is not limited to this. For example, the configuration of connecting an analog telephone device with the VoIP gateway is also applicable to the IP telephone terminal 10 according to the present embodiment. A general purpose information processing device, such as a personal computer, installing a head set for the telephone (microphone and speaker) and a program for implementing the above functions, may also be used.

The router 40 is a path select device (relay unit) with a function to read the IP address of a destination written in an IP packet, and send the IP packet to the optimum direction. The router 40 also has a firewall function for preventing invasion of a third party through an external network. For the firewall function, a known technology, such as an invasion detection system and encryption of the IP packet, can be used. Using this firewall function, the router 40 does not accept an IP packet, and returns a notice to the transmission source if the IP packet received from the communication network 30 does not conform to the conditions being set.

The maintenance server 20 is for providing a service to maintain the IP telephone system in good operation condition. The maintenance server 20 comprises a function for updating and changing the data and the program in the IP telephone terminal 10 when necessary, and a failure recovery function for remotely monitoring the operation status of the IP telephone terminal 10, and notifying the failure contents and performing recovery operation by remote control when a failure occurs. The maintenance server 20 also has a predetermined call control protocol. Here SIP is used, as mentioned above.

The call control server 60 performs call control for managing the calls of each IP telephone terminal 10. Specifically, the call control server 60 stores and centrally manages a predetermined table, where telephone numbers and IP addresses are corresponded, and such information as call history, and implements call control by transmitting/receiving information with each IP telephone terminal 10 according to a predetermined call control protocol. Here the call control device 60 functions as an SIP server since SIP is used as the call control protocol.

The IP telephone terminal 10 and the router 40, and the IP telephone terminal 10′ and the router 40′ are both maintenance targets of the maintenance server 20, but it is assumed that they are installed in different organizations and in different areas. It is also assumed that the IP telephone terminal 10 and the IP telephone terminal 10′ use different call control protocols.

The LAN 50 in the present embodiment is a network constructed by Ethernet, and functions as a transmission path of call control signals and call signals. If another device, such as a personal computer, which is not illustrated, is connected, the LAN 50 also functions as a transmission path of data signals. In such a communication network 30 as the Internet, a plurality of networks are interconnected, and packet data specified by TCP/IP protocol, for example, is transmitted.

[Overview of Call Operation in IP Telephone System]

Now an outline of operation from the start to end of a call in the IP telephone system constructed in this way will be described. First when a call instruction, including the telephone number, is received from an operation via an input/output means, which is not illustrated, the IP telephone terminal 10-1 sends a connection request packet including this telephone number and connection request message to the LAN 50 with specifying the IP address of the call control server 60. Here it is assumed that the telephone number of the IP telephone terminal 10-n is specified. The router 40, which received this connection request packet, sends it to the communication network 30 according to the IP address.

The call control server 60, which received the connection request packet addressed to itself from the communication network 30, acquires the IP address corresponding to the telephone number included in this connection request packet by referring to a predetermined table, and transfers the connection request packet to this acquired IP address (that is, the IP address of the IP telephone terminal 10-n). The IP telephone terminal 10-n receives the connection request packet, and returns a connection possible packet to indicate that connection is possible to the call control server 60 if the IP telephone terminal 10-n itself is in call enabled status. When the connection possible packet is received, the call control server 60 transfers the connection possible packet to the IP telephone terminal 10-1 which sent the connection request.

The IP telephone terminal 10-1 which received the connection possible packet sends a confirmation packet on the receipt of the connection possible packet to the call control server 60, and the call control server 60 transfer this confirmation packet to the IP telephone terminal 10-n. By this, a channel (call) is established between the IP telephone terminal 10-1 and the IP telephone terminal 10-n, and the status shifts to voice conversation enabled status. Then a call is implemented between the IP telephone terminal 10-1 at the outgoing side and the IP telephone terminal 10-n at the incoming side by transmitting and receiving IP packets storing voice signals according to RTP (Real-time Transport Protocol).

[Block Diagram of IP Telephone Terminal]

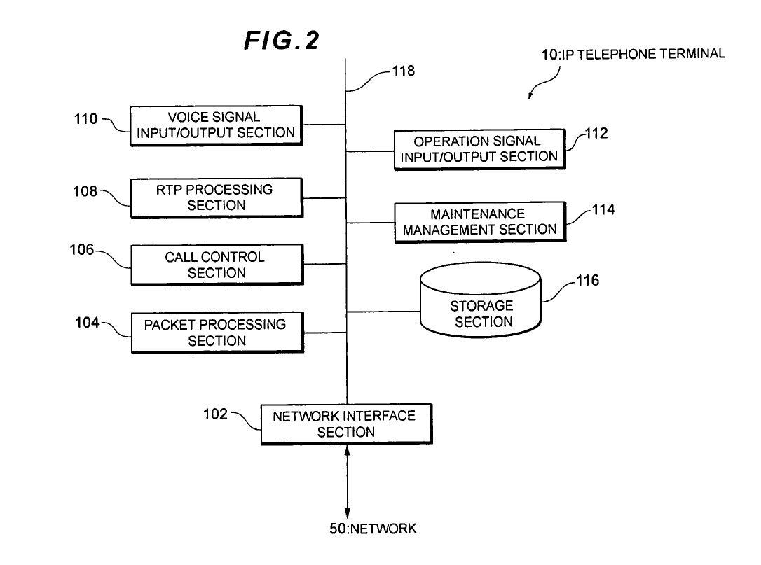

FIG. 2 is a functional block diagram depicting the functions of the IP telephone terminal. The IP telephone terminal 10 comprises a network interface section 102, packet processing section 104, call control section 106, RTP processing section 108, voice signal input/output section 110, operation signal input/output section 112, maintenance management section 114, storage section 116 and internal bus 118.

The network interface section 102 is an interface for physically connecting the IP telephone terminal 10 and the network (LAN) 50. The network interface section 102 physically/logically converts the internal data of the IP telephone terminal 10, and sends it to the network 50, or extracts data addressed to itself flowing on the network 50, physically/logically converts this data, and inputs it to the internal bus 118.

The packet processing section 104 processes packets transmitted to/received from the network 50 via the network interface section 102. The packet processing section 104 removes the IP header from the packet received via the network interface section 102, for example, and reads the TCP/UDP header. And according to the port number of the TCP/UDP header, the packet processing section 104 judges the application to process the packet. For example, if the port number indicates the control data on call control, the packet is transferred to the call control section 106, and if the port number indicates the voice data, the packet is transferred to the RTP processing section 108. The packet processing section 104 also adds a header to the data generated by the call control section 106 or the RTP processing section 108, and sends the data through the network interface section 102.

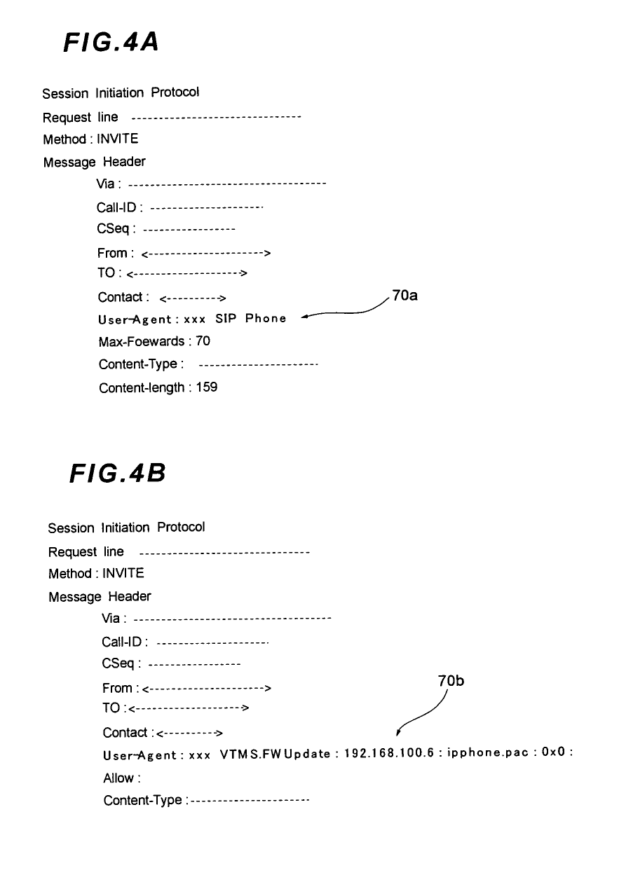

The call control section 106 executes the call processing according to a predetermined call control protocol. If maintenance information is stored in the data according to the call control protocol, the maintenance information is sent to the maintenance management section 114. The call control section 106 of the present embodiment executes the call processing according to the SIP, as mentioned above. The call control section 106 interprets the data in text format described according to a predetermined language for session description (e.g. SDP: Session Description Protocol), and performs request/response type communication with the call control server 60. The configuration of the data according to the call control protocol will be described in FIG. 4.

The RTP processing section 108 relays conversation signals between the voice signal input/output section 110 and the packet processing section 104 according to RTP, which is a higher protocol of UDP, and is a protocol for streaming-reproducing voice and images. The RTP processing section 108 generates voice packets by adding the header information according to RTP to the digital voice signals, which are converted analog voice signals, input by the voice signal input/output section 110, by the voice encoding section, which is not illustrated, and transfers them to the packet processing section 104. If voice packets are received, the RTP processing section 108 rearranges the voice packets based on the header information according to RTP, and transfers them to the voice decoding section.

The voice signal input/output section 110 is a hand set for inputting the voice of the user and outputting the voice of the other party. The analog voice signals, which are input from the voice signal input/output section 110, are converted into digital voice signals, according to a predetermined signal, by the voice encoding section, which is not illustrated. The voice decoding section, which is not illustrated, converts the received digital voice signals into analog voice signals, and outputs them from the voice signal input/output section 110 as analog signals. The operation signal input/output section 112 is, for example, the dial buttons for the user to input telephone numbers, and to input and operate various instructions.

The maintenance management section 114 executes processing according to the accepted maintenance information. For example, if the accepted maintenance information is a request to set a predetermined information (e.g. later mentioned number planning table), the maintenance management section 114 updates the predetermined information being set in itself. If the accepted maintenance information is a request to collect information being set in itself (e.g. status to indicate call status), the maintenance management section 114 acquires the instructed information and sends it back.

The storage section 116 stores various information which the IP telephones 10 needs for a call. For example, the storage section 116 corresponds and stores the telephone number of itself and the IP address, and also stores a table where call destinations and predetermined numbers assigned to call destinations are corresponded (hereafter called the “number planning table”). Specifically, in this number planning table, each call destination and higher several digits of the telephone number assigned to the call destination are corresponded. If the user inputs the telephone number of a call destination, the storage section 116 can specify the call destination by referring to the higher several digits of the number planning table according to the number which was input. The storage section 116 also stores the call control module where connection processing, for connecting the connection destination network, is specified, for each connection destination network to which the IP telephone 10 is connected. For this call control module, a unique module is used for each connection destination network, that is for each carrier which manages the connection destination network. The number planning table and the call control module are updated by the maintenance management section 114.

This IP telephone terminal 10 comprises a CPU, which is not illustrated, ROM for storing programs to be executed by the CPU, and RAM for temporarily storing various information. For example, the call control section 106 is implemented by the CPU executing various controls based on a predetermined control program stored in ROM, or in an external storage device.

[Block Diagram of Maintenance Server]

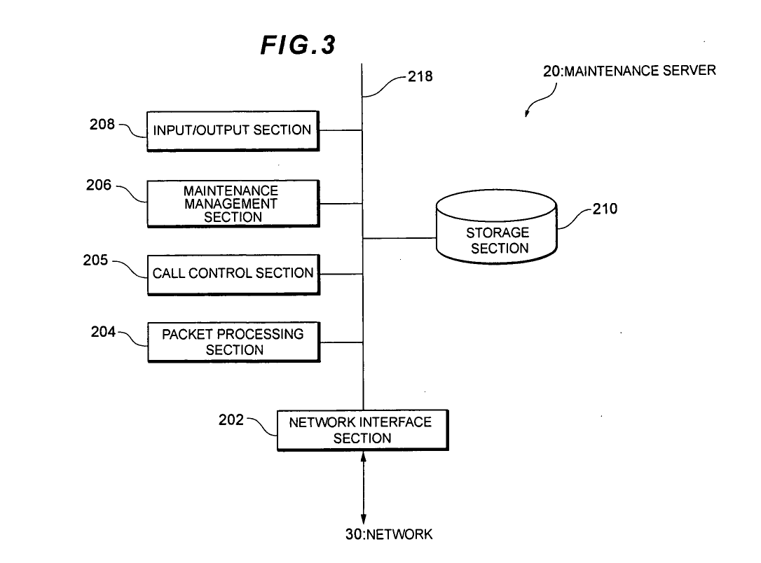

FIG. 3 is a functional block diagram depicting the functions of the maintenance server. The maintenance server 20 comprises a network interface section 202, packet processing section 204, maintenance management section 206, input/output section 208, storage section 210 and internal bus 218.

The network interface section 202 is an interface for physically connecting to the network (Internet). The network interface section 202 physically/logically converts the internal data of the maintenance server 20, and sends it to the network 30, or extracts data addressed to itself flowing on the network 30, physically/logically converts this data, and inputs it to the internal bus 218.

The packet processing section 204 processes packets transmitted to/received from the network 30 via the network interface section 202. The packet processing section 204 extracts the target data from the packets received via the network interface section 202, and transfers it to the maintenance management section 206. The packet processing section 204 also attaches a destination to the data generated by the maintenance management section 206, and sends it via the network interface section 202.

The call control section 205 executes the call processing according to a predetermined call control protocol. The call control section 205 of the present embodiment executes call processing according to SIP. The call control section 205 interprets the data in text format described according to a predetermined language for session description, and performs request/response type communication with the call control server 60, so as to establish a channel with the IP telephone terminal 10. The maintenance management section 206 executes maintenance processing for the IP telephone terminal 10. The maintenance processing includes the registration and update of maintenance information in the storage section 116, and monitoring processing of the IP telephone terminal 10. The maintenance management section 206 reads the predetermined information (e.g. number planning table) stored in the storage section 210, and generates a setting request including the information which was read, and a setting instruction according to the instruction which was input from the input/output section 208 and the conditions which are set in advance. The maintenance management section 206 also generates a collection request including information to be collected (e.g. status to indicate the call status of the IP telephone terminal), and a collection instruction according to the instruction which was input from the input/output section 208, and the conditions which are set in advance. And when information which is sent responding to this collection instruction is received, the maintenance management section 206 stores it in the storage section 210.

The maintenance management section 206 converts the generated setting request and the collection request to the data according to a predetermined call control procedure protocol. The configuration of the data according to the call control protocol will be described with reference to FIG. 4.

The input/output section 208 is, for example, input means, such as a keyboard and mouse, for the user to input a predetermined instruction, and output means, such as a display and speaker.

The storage section 210 stores the maintenance information for the IP telephone terminal 10. The maintenance information is a concept that includes various information for operating the IP telephone terminal 10 appropriately. For example, the control program for operating the IP telephone terminal 10, setting information to be set in the IP telephone terminal 10, and status information to indicate the status of the IP telephone terminal are included in the maintenance information. The storage section 210 also has a management table, which is not illustrated, for managing the maintenance status of each IP telephone terminal, and in this management table, the IP telephone terminal 10 to be the maintenance target and this maintenance information are corresponded and stored.

The maintenance server 20 comprises a CPU, which is not illustrated, ROM for storing programs to be executed by the CPU, and RAM for temporarily storing various information. The CPU operates as the maintenance management section 206, for example, by executing various controls based on predetermined control programs stored in the ROM or external storage device.

[Data Format]

FIG. 4 shows an example of a data configuration according to the present embodiment.

FIG. 4A is an example of the message to be transmitted/received when a normal call control processing is executed. FIG. 4B is an example of a message storing maintenance information to be transmitted/received when the maintenance management processing is executed.

In the present embodiment, the maintenance management information is stored in the header part of the “SIP INVITE message”. Specifically, the maintenance information is written in the “User-Agent” field in the “Message Header” which corresponds to an unspecified portion. In FIG. 4A, the normal information 70a is written in the “User-Agent” field, and in FIG. 4B, the maintenance information 70b is written in the “User-Agent” field.

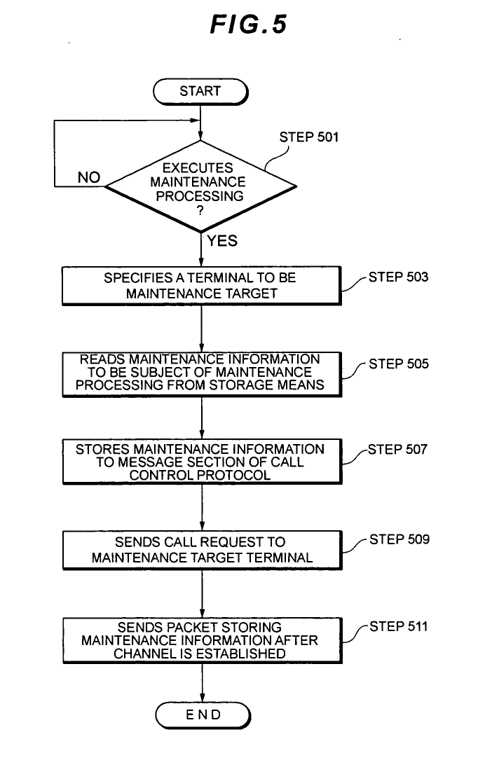

FIG. 5 is a flow chart depicting the processing procedure of the maintenance server. Specifically, the processing contents of the programs of the call control section 205, the maintenance management section 206 and the packet processing section 204 of the maintenance server 20 are shown.

First the maintenance management section 206 judges whether the maintenance processing will be executed or not (step 501). For example, if execution of maintenance processing at a specific time for a specific IP telephone terminal is input via the input/output section 208, the maintenance management section 206 judges that the maintenance processing will be executed. If the access time for the IP telephone terminal 10 or the IP telephone terminal 10 to be the target is set in advance, execution of the maintenance processing is judged according to these settings.

The maintenance management section 206, which judged to execute the maintenance processing, specifies the IP telephone terminal 10 to be the maintenance target according to the information which was input or conditions which were set (step 503). If the maintenance processing is setting predetermined information, the maintenance management section 206 reads the information to be the setting target from the storage section 210 according to the information which was input or conditions which were set, and generates the maintenance information including the information which was read and the setting instruction (step 505).

When the IP telephone terminal to be the maintenance target is specified, and the maintenance information is generated, the maintenance management section 206 stores the maintenance information according to the data format of the call control procedure protocol corresponding to the target IP telephone terminal 10. In this case, the maintenance information is information on processing, which is different from the processing of the call control which is originally scheduled by the call control procedure protocol. Therefore the maintenance management section 206 stores the maintenance information to a predetermined portion which is not used for call control (unspecified portion, such as the “User-Agent” field in the “Message Header”) in the data format of the call control procedure protocol. By this, the IP telephone terminal 10 can interpret and execute the maintenance information without generating errors and problems in the call control processing.

The call control procedure protocol used by each IP telephone terminal 10 may be different depending on the IP telephone terminal, so the information of the call control procedure protocol corresponding to the IP telephone terminal 10 is stored in the storage section 210 in advance, or is input through the input/output section 208.

The call control section 205 sends the connection request packet including the connection information (telephone number) and the connection request message for the IP telephone terminal 10 to the communication network 30 via the packet processing section 204 (step 509). When the channel is established with the IP telephone 10 to the communication network 30 via the call control server 60, the call control section 205 sends the packet storing the maintenance information in the unspecified portion of the call control procedure protocol (step 511). In the case of a normal call, when the channel is established, the IP packets storing voice signals are transmitted/received between the maintenance server 20mat the outgoing side and the IP telephone terminal 10 at the incoming side according to RTP, but here packets storing maintenance information are sent from the maintenance server 20 to the IP telephone terminal 10, instead of the voice packets.

[Processing Procedure of IP Telephone Terminal]

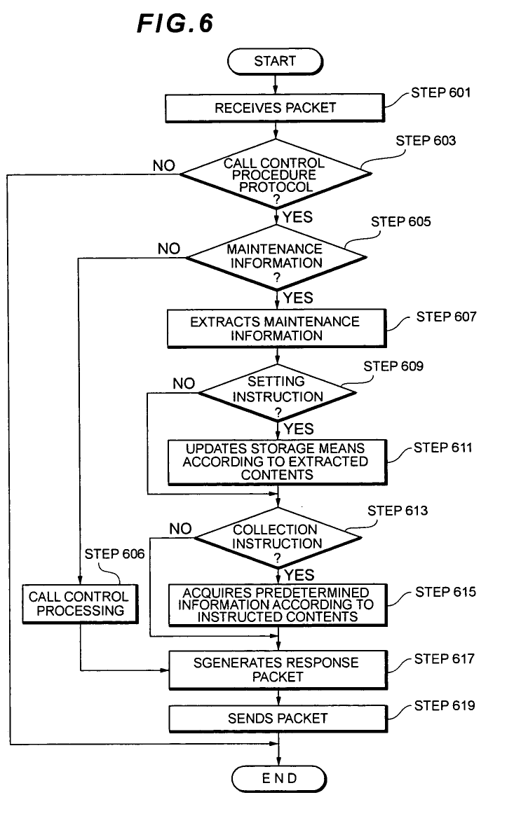

FIG. 6 is a flow chart depicting the processing procedure of the IP telephone terminal 10. Specifically the processing contents of the programs of the packet processing section 104, call control section 106 and maintenance management section 206 in the IP telephone terminal 10 are shown.

When a packet is received via the network interface section 50 (step 601), the packet processing section 104 judges whether the data included in the received packets is data according to a predetermined call control protocol (step 603). If it is judged that the data included in the received packet is data according to a predetermined call control protocol (YES in step 603), the data is transferred to the call control section 106.

The call control section 106 judges whether the transferred data is for transmitting the maintenance information (step 605). Specifically, if the maintenance information is stored in an unspecified portion in the data format of the call control protocol, it is judged that the maintenance information is transmitted (YES in step 605), and maintenance information is extracted (step 607). If information on call control is stored according to the data format of the call control protocol, the data is not for transmitting the maintenance information (NO in step 605), so call control processing is executed (step 606).

Based on the maintenance information extracted by the call control section 106, the maintenance management section 114 executes the maintenance processing. For example, if the maintenance information is an information setting instruction (YES in step 609), the maintenance management section 114 updates the storage section 116 according to the extracted information (step 611). If the maintenance information is an information collection instruction (YES in step 613), the maintenance management section 114 acquires a predetermined information according to the specified contents (step 615). The maintenance management section 114 notifies the maintenance processing execution result to the packet processing section 104.

The packet processing section 104 generates a response packet of which destination is the maintenance server 20 according to the notified contents (step 617), and the network interface section 102 transmits this (step 619).

As described above, according to the present embodiment, the predetermined maintenance information is sent according to the call control protocol corresponding to the IP telephone terminal, so maintenance control for the IP telephone terminal can be executed from the maintenance server installed in the external network.

The predetermined maintenance information can be sent regardless the firewall function of the router 40 to which the IP telephone terminal 10 is connected, so a maintenance server with high universality can be provided.

Also the maintenance information is stored in an unspecified portion of the call control message, so the influence of an error on call control processing of the IP telephone terminal which received this maintenance information can be prevented.

Also by performing maintenance management for the IP telephone terminal installed inside the company from the maintenance server installed outside, the cost for the maintenance operation required for the user of the IP telephone terminal can be decreased.

### Other Embodiments

In the above embodiment, each processing was sequentially described, but the sequence of processings may be changed or processings may be executed in parallel as long as an inconsistency does not occur to the operations. The present invention is not limited to the contents of the above embodiment, but various modifications are possible within the scope of the essential character of the present invention.

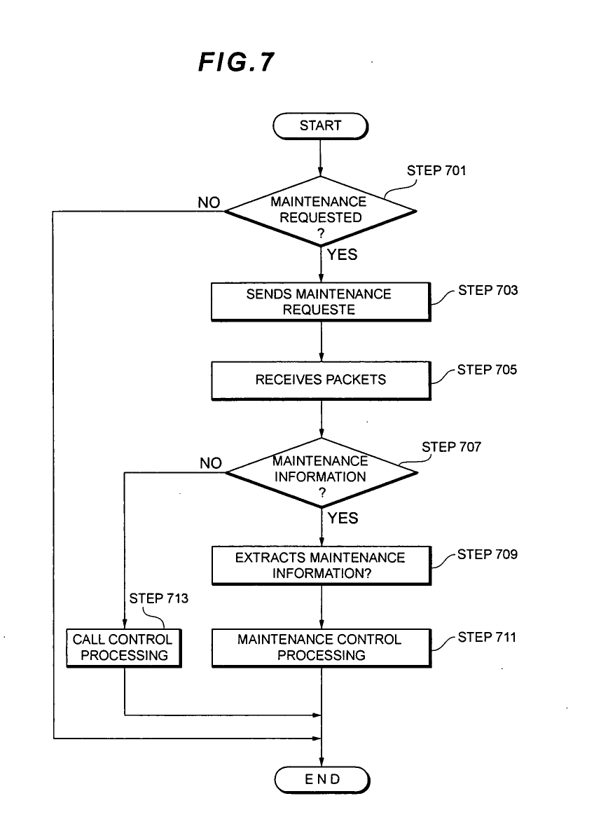

(1) For example, the IP telephone terminal may send a maintenance request to the maintenance server, and responding to this, the maintenance server may send the maintenance information to the IP telephone terminal. FIG. 7 is a flow chart depicting the processing procedure of the IP telephone terminal 10 when the IP telephone terminal sends a maintenance request to the maintenance server.

The maintenance management section 114 judges whether the maintenance will be requested or not according to predetermined conditions (step 701). And if it is judged that the maintenance will be requested (YES in step 701), the maintenance management section 114 generates a maintenance request packet including a maintenance request instruction, and sends the generated maintenance request packet (step 703) via the packet processing section 104 and the network interface section 102. The maintenance server 20 which received the maintenance request packet returns the packet storing the maintenance information according to the procedure in FIG. 5.

When the packet is received, the call control section 106 judges whether the received packet is for transmitting the maintenance information (step 707). Specifically, if the maintenance information is stored in an unspecified portion in the data format of the call control protocol, it is judged that the maintenance information will be sent (YES in step 707), the call control section 106 extracts the maintenance information (step 709), and transfers the maintenance information to the maintenance management section 114. The maintenance management section 114 executes the maintenance control processing according to the received maintenance information (step 711). The maintenance control processing is the same as that in the processings in steps 609-619 in FIG. 6, so description thereof is omitted.

If the information on call control is stored according to the data format of the call control protocol, the maintenance information is not sent (NO in step 707), so the call control section 106 executes the call control processing (step 713).

Because of this, the maintenance server can send the maintenance information for the IP telephone terminal 10 according to the operation and the request from the IP telephone terminal 10.

(2) In the above embodiment, the case when a SIP sequence is used as the call control protocol was described, but the present invention is not limited to this, and can be applied to other sequences according to specifications. The maintenance target is not limited to IP telephones, but can be a gateway and SIP server, for example.

(3) In the above embodiment, the case when both the setting instruction and the collection instruction are included in the maintenance information was described as an example, but only one instruction (e.g. setting instruction) may be included. In FIG. 6, whether the maintenance instruction is a collection instruction is judged after judging whether the maintenance information is a setting instruction, but the sequence of this judgment may be reversed (whether it is a collection instruction is judged first, then whether it is a setting instruction is judged next).

What is claimed is:

1. A maintenance device connected to a terminal device having an IP address via a network, comprising:
generation means for generating a packet storing a predetermined maintenance information for said terminal device in a data format according to a predetermined call control protocol; and
transmission means for transmitting a packet generated by said generation means to said terminal device.

2. The maintenance device according to claim 1, wherein said generation means stores a predetermined maintenance information for said terminal device in an unspecified portion in a message field.

3. The maintenance device according to claim 1, wherein said generation means stores a predetermined maintenance information for said terminal device in text format.

4. The maintenance device according to claim 1, wherein said predetermined maintenance information includes setting information to be set in said terminal device.

5. The maintenance device according to claim 4, wherein said setting information is a control module for executing call processing.

6. The maintenance device according to claim 4, wherein said setting information includes a table where a plurality of call destinations and sequence of numbers assigned to each of said plurality of call destinations are corresponded.

7. The maintenance device according to claim 1, wherein said predetermined maintenance information is a request to collect a predetermined information for said terminal device.

8. A terminal device connected to a server via a network, comprising:
receive means for receiving a packet generated according to a predetermined call control protocol;
extraction means for extracting a predetermined information included in a packet received by said receive means; and
management means for executing processing according to maintenance information if the predetermined information extracted by said extraction means is maintenance information.

9. The terminal device according to claim 8, further comprising call control means for executing processing according to the information on call control if the predetermined information extracted by said extraction means is information on call control.

10. The terminal device according to claim 8, wherein said extraction means extracts said maintenance information from an unspecified portion in the message field of the packet received by said receive means.

11. The terminal device according to claim 8, wherein said extraction means extracts a predetermined information stored in text format in the packet received by the receive means.

12. The terminal device according to claim 8, wherein said management means updates setting contents being set according to said maintenance information if said maintenance information is an information setting request to the management means itself.

13. An IP telephone system, comprising a terminal device having an IP address, and a maintenance device connected to said terminal device via a network, wherein
said maintenance device comprises generation means for generating a packet storing a predetermined maintenance information for said terminal device in a data format according to a predetermined call control protocol, and transmission means for transmitting a packet generated by said generation means to said terminal device, and
said terminal device comprises receive means for receiving a packet transmitted by said transmission means, extraction means for extracting a predetermined maintenance information included in a packet received by said receive means, and management means for executing processing according to a predetermined maintenance information extracted by said extraction means.
